(19) United States
(12) Patent Application Publication
(10) Pub. No.: US 2021/0056523 A1
(43) Pub. Date: Feb. 25, 2021

(54) METHOD FOR MAKING AN ELECTRONIC PAYMENT

(71) Applicant: Surfboard Payments AB, Uppsala (SE)

(72) Inventors: Christopher LINDFELDT, Solna (SE); Neal HINDOCHA, Copenhagen (DK)

(21) Appl. No.: 17/094,323

(22) Filed: Nov. 10, 2020

Related U.S. Application Data
(63) Continuation of application No. 15/768,179, filed on Apr. 13, 2018.

(30) Foreign Application Priority Data
Oct. 13, 2015 (SE) 1551320-3

(51) Int. Cl. G06Q 20/12; H04W 4/00; G06Q 20/32; H04W 4/80; G06Q 20/40; G06Q 20/18; G06Q 20/38; G06Q 20/34; G06Q 20/20

(52) U.S. Cl. CPC G06Q 20/12; H04W 4/00; G06Q 20/32; H04W 4/80; G06Q 20/405; G06F 21/35; G06Q 20/385; G06Q 20/4012; G06Q 20/34; G06Q 20/204; G06Q 20/3278; G06Q 20/18

(57) ABSTRACT

A method for making an electronic payment includes, at a first time, inserting a physical payment card into a physical device of a first point of sale. The device is arranged to electronically read payment card information sufficient to perform the electronic payment. An option is presented as to whether to store the card information. A physical item that is not the payment card is identified and the payment card information is associated in a central server with information identifying the physical item. At a later, second, time a use is authenticated by a second point of sale based upon the item identifying information. Electronic payment using the payment card information is then performed.

This application is a continuation application of U.S. patent application Ser. No. 15/768,179, filed Apr. 13, 2018, which is a National Phase of International Application No. PCT/SE2016/050991, filed Oct. 13, 2016, and claims the benefit of Swedish Patent Application No. 1551320-3, filed Oct. 13, 2015, all of which are incorporated herein by reference in their entireties.

The present invention relates to a method for making an electronic payment. In particular, the invention relates to making such a payment using a payment card and involving a payment card reader.

There is a broad spectrum of solutions for allowing users to make electronic payments, in particular small money amount payments, both at physical points of sale and online points of sale. A general problem in this field is how to tie a purchasing user to a verified money account from which the payment is to be drawn.

One option is to use a payment card of the user. Herein, the term “payment card” may refer to a credit card, a debit card, a pre-charged payment card, or any other physical card which may be used to effectuate payments at various points of sale. Such a payment card typically comprises payment card information which may be stored, in a secure manner, and used to effectuate the payment for a good or a service at a point of sale.

Many solutions have been proposed to store such payment card information for use when making purchases, such as secure online storage of the payment card information or to allow the user to manually enter the payment card information as a part of the purchase transaction process.

However, users tend to perceive it as cumbersome to provide payment card information when performing purchases at points of sale, in particular online. Furthermore, there are security and usability implications in providing payment card information.

It is also a problem that a user has to carry a payment card physically in order to be able to use it for making purchases.

Also, in many cases users have a desire to pay for other users' purchases of products or services. For instance, this is frequently the case for parents, wanting to allow their children to be able to purchase products, perhaps within set economic boundaries, and pay for the products or services on behalf of the children.

The present invention solves the above described problems.

The previously published documents U.S. Pat. No. 8,280,793 B1, US 2001037310 A1, US 2004248554 A1, US 2013204722 A1, US 2014040145 A1, US 2015170128 A1 and WO 2013020086 A1 all describe related solutions. However, neither of these documents solve the above described problems in a satisfactory way. In particular, they do not propose to allow a user to register payment card information using a physical payment card reader, to associate it with a physical item and to use the physical item as authentication for subsequent purchases.

Hence, the invention relates to a method for making an electronic payment, characterised in that the method comprises the following steps, in order: a) at a first point in time, providing a physical payment card from a first user to a first point of sale; inserting the payment card into a physical device of the first point of sale, which device is arranged to electronically read payment card information from the payment card, which card information is sufficient to perform said electronic payment; b) presenting to the first user an option whether to store the card information or not; c) in case the first user responds that the card information is to be stored, identifying a physical item, which is not the payment card, which physical item is held by the user, and associating, in a central server, the payment card information with an electronically stored piece of item identifying information identifying the physical item, or another piece of information which in turn is associated with the piece of item identifying information; d) at a second, later, point in time, authenticating a second user by a second point of sale, which authentication is based upon the item identifying information; and e) in case the authentication in step d was successful, performing the electronic payment using the payment card information.

In the following, the invention will be described in detail, with reference to exemplifying embodiments of the invention and to the enclosed drawings, wherein:

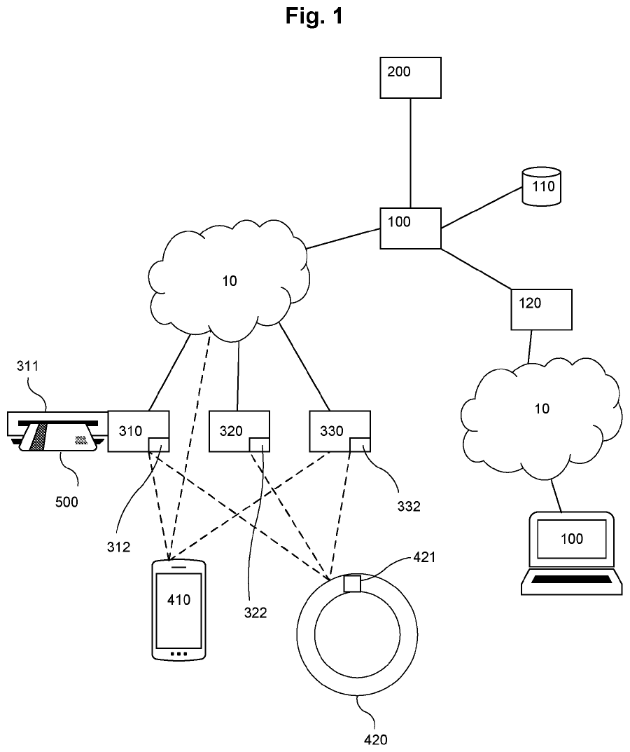

FIG. 1 is an overview diagram of a system arranged to perform a method according to the present invention;

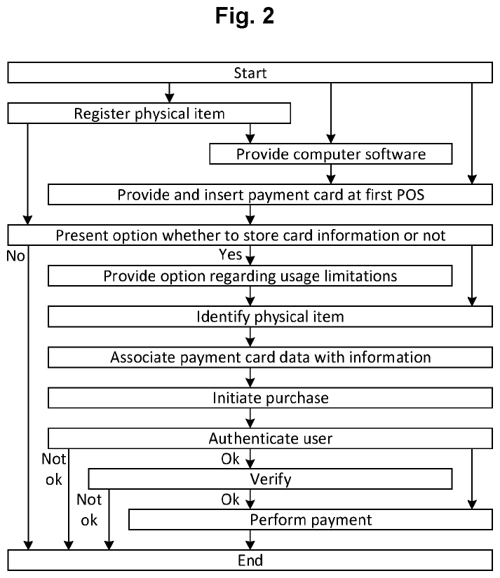

FIG. 2 is a flow chart illustrating an embodiment of the present invention;

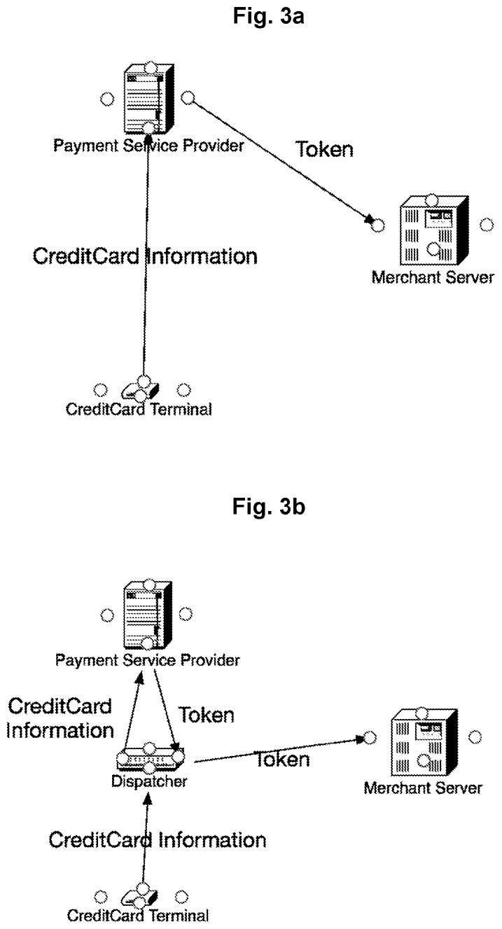

FIGS. 3a-3c illustrate three alternative ways of producing and distributing a token according to the invention; and

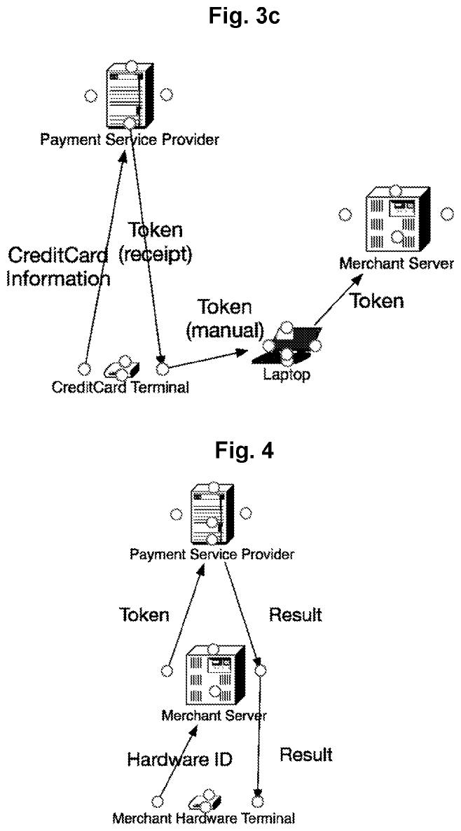

FIG. 4 illustrates a way of performing a purchase according to the invention, using such a token.

FIG. 1 illustrates a system arranged to perform a method according to the present invention for making an electronic payment. The system at least comprises a central server 100, in turn comprising or being connected to a database 110. Preferably, the system also comprises a web server 120 or other user interface providing device, arranged to provide an interface to a user of the present method using which the user, over a secure communication line such as an encrypted internet 10 connection, can administer and configure user-specific information, such as registered payment cards; rules applicable to the use of such payment cards; bank account information; and so forth. Hence, the user may preregister payment cards, for use in the system, with the user interface providing device 120, and the user may also, via the device 120, change operating details for payment cards that have been registered via the reader 311 (see below).

The central server 100 may be implemented as one standalone physical server and/or logical sever instance, or may be distributed across several, interconnected, such physical and/or logical server instances, as is conventional as such for servers in general. The web server 120 may be an integrated part of the central server 100 or a standalone server. The corresponding is true regarding the database 110.

The server 100 and the web server 120 are preferably connected to the internet 10 for communication with at least one, preferably a plurality, of points of sale 310, 320, 330. Such a point of sale may be a physical point of sale or a virtual (online) point of sale. According to the invention, at least one, preferably several, such point of sale 310 is a physical point of sale comprising a respective payment card reader 311.

Each point of sale 310, 320, 330 further comprises a respective reading means 312, 322, 332, arranged to read a piece of item identifying information (see below) from a physical item 410, 420. This reading is either physical, using wireless communication between the item 410, 420 and the reading means 312, 322, 332, or it may take place over the internet, as described below.

The payment card reader 311 is preferably a conventional, physical payment card reader, of the type which is today present in most physical points of sale, such as in stores and service outlets. Examples of payment card readers comprise those arranged to read a magnetic stripe and/or an electronic circuit of a payment card and thereby receive information from the payment card, and those that are arranged to read information from a payment card via a wireless communication technique, such as NFC.

A “payment card”, as used herein, refers to a physical payment card arranged to be read by such a payment card reader 311. Hence, the payment card has a standardized size and shape, and comprises a magnetic stripe; an electronic circuit; an NFC means; or other conventional means for communicating with such a payment card reader and thereby provide payment card information to the payment card reader. Examples of such payment cards comprise bank and credit cards and also customer loyalty- and membership cards, and the like. In all cases, such a payment card is associated with a payment channel, so that the mentioned payment card information, stored on the payment card, provides access to a payment service.

Furthermore, a user of the system holds a physical item which is not the payment card. Herein, that the user “holds” the physical item means that the user has physical access to the item. The user may be the owner of the physical item, or at least controls the physical item. The control over the physical item results in that it may be used as a “possession type” (“something you have”) authentication factor for the user, in other words may be used by the user to prove the user's identity by the user demonstrating access to the physical item to a party questioning the identity of the user. In order to qualify as such a possession type authentication factor, the physical item has certain item identifying information (see below), which is tied to the physical item as such, making it possible for a questioning party to tell one such physical item apart from another physical item, and making it possible to verify a previously stored association between the particular physical item and the user.

In FIG. 1, such physical items are exemplified using a mobile electronic communication device in the form of a conventional smartphone 410, and an NFC-enabled (Near Field Communication) ring 420, comprising an NFC circuit 421. The ring 420 may, for instance, be worn on the finger of the user.

The phone 410 has at least one wireless digital communication capability, using which digital information can be transmitted to a receiver. One example of such capability is a mobile telephony communication ability, such as a GPRS, 3G, 4G or LTE, or a WiFi capability, using which the phone 410 can communicate digitally with other internet 10 connected devices. Another example of such capability is an NFC, Bluetooth® or similar capability, arranged to provide local wireless communication to locally arranged devices. Similarly, the ring 420 may communicate locally and wirelessly with other locally arranged devices via the NFC interface.

In FIG. 1, broken lines indicate wireless communication links, whereas solid lines indicate communication links that are preferably wired but that may also be wireless or comprise wireless parts.

FIG. 2 illustrates a method in accordance with the present invention. In a first step, the method starts.

In an optional, initial step, at least one physical item 410, 420 is registered with the central server 100, together with a corresponding respective piece of item identifying information, for subsequent use with the method of the invention. The piece of item identifying information is preferably associated with the user in the database 110, such as using a previously registered user account on the central server 100. It is noted that the physical item may also be registered later, before it is to be identified for use with the payment card 500 (see below).

Herein, a piece of “item identifying information” is a piece of information using which a particular physical item 410, 420 can be identified, preferably uniquely identified. As such, the item identifying information is specific, and in particular preferably unique, to the physical item in question. In particular, it is preferred that the item identifying information is specifically tied to, and preferably readable from, electronic hardware comprised in the physical item. The item identifying information is further preferably readable directly from the physical item, preferably using a wireless communication technology implemented by the physical item in question itself. Examples comprise a MAC address, UDID number or IMEI number of a mobile communication device; an MSISDN or IMSI number of a SIM card installed in a mobile communication device; an IMEI, UDID or serial number, or an NFC or Bluetooth® name or address, of a wireless device arranged to communicate via NFC or Bluetooth®, and similar. The item identifying information may also be accessible from the physical device via a software function which is executable on or from the physical device in a manner which securely couples the item identifying information to the physical item as such. For instance, a software function installed on or accessed by the smartphone 410 may be arranged to provide, after proper authentication of the user by the software function, such as by the user providing authentication credentials to the software function, the item identifying information wirelessly to a recipient. In this case, the software function needs to be installed on the smartphone 410 in a way that securely ties it to the smartphone 410 as such, for instance by an initial installation procedure performed via a secure channel to the central server 100. Hence, the item identifying information may be physically tied to, such as integrated into, the physical item, or, alternatively, it may be securely tied to the physical item using a secure remote channel.

The reading of the item identifying information is preferably electronic, and further preferably performed by local, wireless digital communication between the physical item 410, 420 and a point of sale 310, 320, 330, preferably at a maximum distance between the physical item 410, 420 and a corresponding receiver at the point of sale of 20 meters.

In another optional initial step, the payment card reader 311 is provided with a piece of computer software, providing the payment card reader 311 with particular functionality (see below).

In a next step, performed at a first point in time, a physical payment card 500 is provided from the user to a first point of sale 310, and inserted into a physical device, such as the card reader 311, of the first point of sale 310. What is important is that the device 311 is arranged to electronically read card information from the payment card 500, which card information is sufficient to perform an electronic payment using the card 500 as described above. Typically, such information comprises at least some of card serial number; expiration date; card name; and CVC/CVV code.

In a next step, an option is presented to the user whether to store the read card information or not. This option may, for instance, be presented in an automatic manner, using the display of the card reader 311 or another screen comprised in the point of sale 310; or, less preferably, in the form of a manually posed question by personnel at the point of sale 310. In case the user opts not to store the card information, the method skips to a step in which the payment card 500 is used to pay for a purchased product in a conventional manner, or not used at all, after which step the method ends. Hence, in case the user selects “no”, the method according to the present invention may provide a user experience which is virtually identical to the conventional user experience when using a payment card with a conventional card reader.

It is noted that the first point of sale 310 is physical at least in the sense that it comprises the physical device 311 arranged to read the card. As such, it may be a store or other conventional attended physical point of sale, but it may also be an unmanned point of sale (UPT—Unattended Payment Terminal), such as for instance an automated vending machine offering the capability of accepting card payments. Another option is that the first point of sale 310 is a temporary or non-stationary point of sale operated using a mobile physical card reader 311 communicating wirelessly via the internet 10.

According to an optional but preferred step, the user is then also presented with an option as to for what types of purchases the stored card information is to be used and/or at what points of sale the stored card information is to be used and/or a purchase limit to be associated with the stored card information. For instance, the user may be able to specify that the stored card information is only to be used for the purchase of predetermined lunch tickets at a particular chain or restaurants or even at a particular restaurant; or that the stored card information is only to be allowed for use up to a specific maximum money amount each month. These options, regarding usage restrictions or limitations, may be presented to the user in a way which is similar to the option described above, whether to store the card information or not at all. Different points of sale may employ different types of available selections as to such usage limitations. It may also be possible to, in a corresponding manner, register a standard product and/or payment amount to always use for the registered payment card 500 (see below). Such operating parameters for each registered payment card may then be further set or altered using the web server 120, at the convenience of the user.

In case the first user responds in the positive, that the card information is to be stored, in a next step a physical item 410, 420, which is not the payment card 500, is identified. The physical item may be a smartphone 410 or an NFC-enabled item 420 such as described above, but may also be any type of item with the above described properties, such as any Bluetooth®, NFC, ZigBee or RFID device. What is important is that it is not necessary or even preferred that the physical item is primarily arranged for, or even provided with the intention to, act as a possession-type identification factor for a user, as long as the point of sale 310 can read a device-specific piece of item identifying information from the physical item. Even, according to a preferred embodiment, the point of sale 310 only requires the physical item 410, 420 to support one of a particular set of one or several wireless communication standards, which standards imply the possibility to read such a device-specific piece of item identifying information from the physical item as a part of the communication between the point of sale 310 and the physical item using said communication standard. The communication standards may, for instance, be one or several from Bluetooth®, NFC, ZigBee and WiFi.

The identification of the physical item 410, 420 may take place in different ways.

In case the item was registered in the above described initial step, it may be selected by the user, such as using a display of the payment card reader 311 or using an interactive screen display interface provided in another way by the point of sale 310. In this case, the item identifying information may have been registered with any point of sale 310, 320, 330 connected to the central server 100.

Another option is that the reading of the item identifying information is performed by the point of sale 310 in connection to the reading and registration of the payment card 500 by the point of sale 310. In this case, the identification is preferably conducted using the reading means 312.

According to the invention, the physical item is held by the user (as described above), hence constituting a possession-type authentication factor of the user.

In a next step according to the invention, the payment card is associated, in the central server 100, with an electronically stored piece of information, which may be the above described item identifying information, identifying the physical item 410, 420, or another piece of information which in turn is associated with the piece of item identifying information. What is important is that the central server 100 can verify whether or not a particular physical item, identified by a particular piece of item identifying information, as read using the reading means 312, 322, 332, has been registered for use with a particular payment card 500 based upon the electronically stored piece of information.

It is realized that one and the same user may register one or several physical items 410, 420 for one or several payment cards 500, and that each such combination of a physical item and a payment card may be associated with different payment restrictions in the database 110.

According to a preferred embodiment, account information, identifying a money account of the user, is registered in the central server 100 for the user. This money account may or may not be associated with the payment card 500, and may for instance be tied to a loyalty program or similar, or be associated with another payment card. In this case, such money account is also associated to the payment card information in the central server 100. Then, the user is preferably allowed to select a certain threshold value of the money on said money account, such as using the above described user interface at the point of sale 310, and a transfer of funds is arranged to then be automatically performed from the payment card 500 to said money account when the balance of the money account falls below the threshold. Any payments performed using the physical item 410, 420 as described below will then be debited to the money account rather than the payment card 500 directly.

At this point, the payment card 500 information is registered and stored in the database 110 of the central server 100. Similarly, the item identifying information is securely registered and also stored in the database 110, in association with the payment card 500 information. Therefore, the physical item 410, 420 can be used as a proxy for the payment card 500 for subsequently making payments using the payment card 500 as means of payment. It is possible to do this in a secure manner since the payment card 500 information was registered by manual, physical reading of the payment card 500 at a point of sale 310, and further since the physical item 410, 420 identifying information was securely registered, either via physical, local reading or in any other secure manner.

In a next step, performed at a second, later, point in time, a second user, which may be the same as the above described user or a different user, initiates a purchase at a second point of sale 310, 320, 330, which second point of sale may or may not be the same as the above discussed point of sale 310. The second point of sale may or may not be a physical point of sale. In case the physical item identifying information is transferred via the internet to the reading means 312, 322, 332, the second point of sale needs not be a physical point of sale, but may for instance instead be an online point of sale.

Then, according to the invention the second user is authenticated by the second point of sale.

It is preferred that this authentication, as well as the preceding payment (see below) is performed without use of the physical payment card. This means that the payment card as a physical item is not needed in these method steps, and needs not be physically present during the process. To the contrary, the payment card information is used, but not read from the payment card but from the database 110.

The authentication of the second user is based upon the stored piece of item identifying information described above. It is important to understand that this authentication may or may not be specifically directed to the identity of the second user. For instance, in case the users are one and the same, and the payment card 500 belongs to the user, the user may be required to enter a personal PIN code or the like (see below) in connection to the authentication. However, according to another preferred embodiment, it is the physical item 410, 420 as such which is the bearer of the authentication, and whoever holds the physical item 410, 420 can also use the payment card 500 under the particular conditions registered for that particular combination of payment card and physical item. This way, a user may register several physical items 410, 420, and distribute one such physical item each to persons eligible for paying using the payment card 500. For instance, such persons may be family members or receivers of a special promotion from a company. Such distributed physical items may for instance be associated with narrow purchase restrictions in the database 110, as described above. Since, in principle, any wireless hardware communication device may be used as the physical item, receiving users may use their already existing devices as physical items. Alternatively, inexpensive, simple wireless devices may be distributed to receiving users at low cost.

It is preferred that the authentication is performed by the item identifying information being transferred wirelessly from the physical item 410, 420 to the reading means 312, 322, 332 of the point of sale 310, 320, 330 in question, preferably locally at a maximum distance of 20 meter from a corresponding receiver in the point of sale in question.

Alternatively, the authentication may be performed using the above described (or a similar) software function executed on or by a smartphone 410, as described above, providing smartphone 410 identifying information to the point of sale in question or the central server 100. In this latter case, it is not necessary that the physical item is physically proximate to the point of sale, as described above. It is understood that the reading means 312, 322, 332 in this case may also be a part of the central server's 100 functionality.

In particular in the latter case, the item identifying information may comprise an MSISDN or IMSI code of the mobile device 410 controlled by the user. Then, the authentication comprises the central server 100 or the point of sale 310, 320, 330 in question interacts with the mobile device 410 in question as identified using said MSISDN or IMSI code.

In one preferred embodiment, the authentication comprises sending an SMS message to the mobile device 410 having the SIM card, which SMS message comprises a code. Then, the code is provided to the point of sale 310, 320, 330 in question or to the central server 100 by the user, to the appropriate reading means 312, 322, 332.

The authentication may also comprise the user having to enter a PIN code, or another password, via an interface, to the point of sale 310, 320, 330 in question or to the central server 100, in order to further increase the security of the authentication in case the physical item 410, 420 is lost by the user. The PIN code may be entered using an interactive interface provided by the above described software program executing from or by the smartphone 410; by the point of sale 310, 320, 330; or via another channel, such as over the internet 10 directly to the central server 100.

In general, in the case of the physical item being a mobile device such as the smartphone 410, it is further preferred that the authentication comprises the point of sale 310, 320, 330 in question or the central server 100 electronically interacting with such a software program executing on or from the mobile device 410 and securely tying the mobile device 410 to the user. This interaction may be performed automatically, on the initiative of the software function, the point of sale 310, 320, 330 or the central server 100, and comprises a step in which the user interacts with the mobile device 410, which interaction securely identifies the mobile device 410 and the occurrence of said user interaction step to the point of sale 310, 320, 330 in question or the central server 100. One example is the user being forced to enter the mentioned PIN code on the screen of the smartphone 410; or the user having to press a confirmation button appearing on the screen of the smartphone 410, possibly showing information about the purchase to be made at the point of sale 310, 320, 330 in question. It is in connection to such steps that the reading means 312, 322, 332 receives the item identification information for comparison to the previously stored such information and subsequent authorization of the user.

In the alternative case in which the item identifying information is carried by an electronic transfer device 420 arranged to transfer said item identifying information to points of sale 310, 320, 330 using a local wireless communication, such as a nearfield wireless transmission, the authentication preferably comprises transferring said item identifying information to the reading means 312, 322, 332 of the second point of sale 310, 320, 330 from the electronic transfer device 420 and verifying the information received. This verification may be performed by the point of sale 310, 320, 330 or by the central server 100.

Preferably, the electronic transfer device 420 comprises a transmitter means 421, in the form of an NFC, passive RFID, active RFID, or similar (described above), transmitting device, arranged to transfer said item identifying information to the reading means 312, 322, 332.

In this case, the electronic transfer device 420 is preferably not arranged with a user interface, such as a screen of physical buttons, via which the user can change said item identifying information. Such an electronic transfer device 420 can be made very inexpensive, for instance comprising a passive RFID circuit or a battery-powered active RFID circuit, allowing distribution of many such devices 420 to different users for use when paying for products, such as a part of a promotion. Alternatively, the transfer device 420 is a part of a more complex hardware product, such as a laptop computer or any other type of equipment, which also has NFC or similar functionality.

As is clear from the above, it is preferred that all connected points of sale 310, 320, 330 have the capability to authenticate users by reading item identifying information from respective physical items 410, 420 in the above described ways. Such reading may be performed locally, by the point of sale in question, in which case the point of sale must be arranged with a locally arranged physical item reading receiver, or it may be performed by direct contact between a mobile device 410 and the central server 100. The authentication itself, that is, the comparison between the supplied item identifying information and the previously electronically stored piece of information in the database 110, may be performed by the central server 100 (which is preferred) or the point of sale 310, 320, 330.

Common to all embodiments is that the payment card 500 has always been read by a physical payment card reader 311 prior to use for making payments using the present invention.

Then, in case the authentication was successful, in a next step according to the invention, the payment is performed using the previously stored payment card 500 information. For instance, this may be performed by the second point of sale 310, 320, 330 receiving said payment card information from the central server 100 and performing the electronic payment based thereupon. Alternatively, the central server 100 may perform the payment using a payment service provider 200, such as a bank, which is connected to the central server 100.

Hence, the payment card 500 needs not be present in this payment performance. Instead, the use of the payment card information is authenticated in a way which is mediated by the requesting user's access to the physical item associated in the central server 100 to the payment card 500.

Finally, a receipt is preferably sent to the user, such as electronically to the smartphone 410 or any other electronic device or inbox of the user. Alternatively, a written receipt may be printed at the point of sale, such as using a printer connected to the terminal.

In a preferred step in connection to the above described authentication or, less preferred, in connection to the payment step, the second point of sale provides information to the user, such as via an interface of the point of sale in question or on the smartphone 410, regarding the amount to be drawn from the payment card. The user is presented with an option whether or not to confirm the transaction using said amount. In case the user replies in the negative, the method ends.

In a particularly preferred embodiment, a standard product and/or payment amount is registered as described above and associated with the payment card 500 information in the central server 100, in which case the second point of sale uses the payment card information to draw a payment amount, as a predetermined amount or a payment for a standard product, from the payment card 500, preferably without the user being presented with an option whether or not to confirm the transaction using said amount. This makes it possible for a merchant to easily provide customers with an easily accessible way of paying for standardized products, such as a lunch or a cup of coffee.

In a preferred embodiment, the user is allowed to register several pieces of item identifying information for one and the same payment card 500, wherein different such pieces of item identifying information are associated with the same or different users. In this case, such registered pieces of item identifying information are associated with one and the same payment card information in the central server 100 upon such registration.

Furthermore, in the preferred case in which the central server 100 is arranged to provide the above mentioned web server 120, or any other suitable remotely accessible user interface, it is preferred that the interface is arranged to allow the user to, via the interface, remotely administer the various types of information stored in the central server 100 and/or associated therein to the payment card 500 information, as described above. This preferably comprises adding new payment cards; removing payment cards; entering payment limitations; removing registered physical items; and so forth.

In the preferred case in which the payment card reader 311 is provided with a piece of computer software, as mentioned above, the execution of this software preferably causes the payment card reader 311 to do at least one of the following above described steps: presenting the option to the user whether or not to register the payment card 500; providing the payment card information to the central server 100; collecting the item identifying information from the user via an electronic interface; providing the item identifying information to the central server 100; and authenticating the user at said second point in time.

Using a method according to the present invention, the initially identified problems are solved. In particular, the user can easily register a payment card 500 using a conventional card reader, using conventionally accepted security standards, at a first point of sale together with a physical item 410, 420, and then use the physical item to perform purchases at the same or different points of sale. It is furthermore easy to delegate purchasing power to family members or the like.

The following is three examples of use cases falling within the scope of the present invention.

### EXAMPLE 1: USER REGISTERS PAYMENT CARD WITH PHYSICAL ITEM (HARDWARE DEVICE)

Use case: Physical payment card connected to hardware device (physical item)
Summary: User connects payment card to a hardware device with wireless communication technology
Primary actor: Consumer
Precondition: The consumer has a valid physical payment card, and is physically present at a point of sale terminal
Post condition: Consumer has a hardware device that can be used for payments, where payments are taken from the payment card

### Success Scenario:

1. Consumer inserts payment card into point of sale terminal
2. Consumer is able to successfully make payments with payment card
3. Point of sale terminal sends payment card information to central server and/or to payment service
4. Hardware ID is registered in central server, either via point of sale terminal or in a secondary terminal
   a. Alternatively, the hardware ID is already in the central server because the hardware device is provided by the vendor
5. Payment service creates a token
6. Token is connected with hardware ID, such that it can only be used by the registered hardware device
   a. This connection occurs either in the payment service/payment server, or the token is sent by the payment service/server to a secondary server/service
7. User is able to use the hardware device for purchases, effectively using it as a replacement for the payment card

### EXAMPLE 2—USER REGISTERS PAYMENT CARD WITH HARDWARE DEVICE AND PIN CODE

Use case: Physical payment card connected to hardware device with PIN authentication
Summary: User connects payment card to a hardware device with wireless communication technology, with a PIN or passphrase that can be used for purchases
Primary actor: Consumer
Precondition: The consumer has a valid physical payment card, and is physically present at a point of sale terminal
Post condition: Consumer has a hardware device that can be used for payments when combined with PIN, where payments are taken from the payment card

### Success Scenario:

1. Consumer inserts payment card in point of sale terminal
2. Consumer is able to successfully make payments with payment card
3. Point of sale terminal sends payment card information to server and/or payment service
4. Hardware ID is registered in central server, either via point of sale terminal, or in a secondary terminal
   a. Alternatively, the hardware ID is already in the central server because the hardware device is provided by the vendor
5. Payment service creates a token
6. Token is connected with hardware ID, such that it can only be used by the registered device
   a. This connection occurs either in the payment service/payment server, or the token is sent by the payment service/server to a secondary server/service
7. User selects a passphrase/PIN code, which is entered on the point of sale device, or a secondary device
   a. The passphrase/PIN can also be pre-selected and provided by the vendor
8. Token and hardware ID information is stored in the server/service, together with the passphrase/pin.
9. User is able to use the hardware device for purchases when combined with passphrase/PIN, effectively using it as a replacement for the payment card

### EXAMPLE 3—USER REGISTERS PAYMENT CARD WITH HARDWARE DEVICE FOR FIXED VALUE PURCHASES

Use case: Physical payment card connected to hardware device
Summary: User connects payment card to a hardware device with wireless communication technology
Primary actor: Consumer
Precondition: The consumer has a valid physical payment card, and is physically present at a point of sale terminal
Post condition: Consumer has a hardware device that can be used for fixed value purchases

### Success Scenario:

1. Consumer inserts payment card in point of sale terminal
2. Consumer is able to successfully make payments with payment card
3. Point of sale terminal sends card information to server and/or payment service
4. Hardware ID is registered in central server, either via point of sale terminal, or in a secondary terminal
   a. Alternatively, the hardware ID is already in the central because the hardware device is provided by the vendor
5. Payment service creates a token
6. Token is connected with hardware ID, such that it can only be used by the registered device
   a. This connection occurs either in the payment service/payment server, or the token is sent by the payment service/server to a secondary server/service
7. User is able to use the hardware device for fixed value purchase, by simply swiping/connecting/using the hardware device over a terminal

Above, a “token” is a piece of coded information used by the central server 100 to identify a payment card. Such a token can be freely distributed, since it is associated with a particular set of point of sales that the user has allowed for debiting using the payment card. The central server 100 will only accept to perform requested purchases in case a requesting point of sale identifies as such an authorized point of sale to the central server 100. This identification may take place in a manner which is conventional as such. Hence, a vendor can receive and hold such a token after being securely registered with the central server 100. Thereafter, when the user is authorized to the vendor, using the physical item as described above, the vendor uses the token which is associated with the physical item to initiate a payment to the vendor, such as for a product or service sold to the user. This latter can be performed in communication with the above described payment service provider.

FIGS. 3a-3c illustrate alternative detailed implementations specifically regarding the handling of the token by the system.

In the first alternative, illustrated in FIG. 3a, the payment card information is provided from the point of sale terminal to a payment service provider, such as a bank (which may be operated by or in cooperation with the central server). The payment service provider creates a token, and sends it to the vendor (“Merchant Server”) which operates one or several points of sale that are authorized for payment by the user using the physical item in question. The vendor then uses the token for identifying the payment card associated with a physical item provided by a user.

In the second alternative, illustrated in FIG. 3b, there is a dispatching means which receives the payment card information from the point of sale terminal. Then, the payment card information is provided to the payment service provider which in turn provides a token back to the dispatching means. Finally, the dispatching means provides the token to the authorized vendor.

In the third alternative, illustrated in FIG. 3c, the point of sale terminal provides the payment card information to the payment service provider, which returns a token which is displayed to the user by the point of sale terminal. The token is then manually input, by the user, into a different system, such as a user laptop, and transferred there through to the vendor.

FIG. 4 illustrates a practical case of a purchase using such a token, irrespectively of how the token ends up at the vendor. In this example, the above described central server 100 is located with the vendor.

A point of sale terminal of the vendor reads the hardware ID of the registered physical item, using NFC, Bluetooth® or similar, as described above, and sends this information to the vendor's server. A user PIN code may also be stored in the latter server. The vendor checks which token that is connected to the hardware ID in question by a database lookup, and sends the token, together with information regarding the purchase (such as products to be purchased and money amount), to the payment service provider. A receipt is returned, which is shown to the client at the vendor's point of sale terminal.

The process of creating a token (“tokenization”) as such is well-known and standardized. For instance for payment card numbers it has been defined in ANSI X9.119 part 2 (see http://x9.org/wp-content/uploads/2014/01/X9-Tokenization-Webinar-January-2014.pptx). How the token is created and how it looks is, in the end, up to the individual payment service provider.

The following is a description of yet another exemplifying embodiment falling within the protective scope of the present invention, in which a user uses his or her smartphone as the above described physical item.

In a first step, the user introduces the payment card into the payment card reader at the vendor's terminal (the point of sale).

In a second step, the user makes a payment using the payment card, during the course of which a question is posed to the user whether he or she wishes to register the payment card. The user selects “yes”, and enters information uniquely identifying the smartphone as such, such as a telephone number into the terminal (or a separate user interface device at the point of sale) to the smartphone of the user.

In a third step, the central server, in response to a message sent from the point of sale with said telephone number, sends a direct message to the smartphone, such as an SMS message to the telephone number, with an internet link.

In a fourth step, the user opens the link received by the smartphone, for instance by clicking it in the SMS application used by the smartphone, which results in the smartphone initiating a process during which the user can register with the system, such as by installing a native application on the smartphone and/or interacting with an interactive web site and/or registering for an account securely tying the user to the account and preferably also to the smartphone as such.

In a preferred fifth step, the user brings the smartphone into local wireless contact to the point of sale (such as reading means 312) in a way so that the point of sale can read the above described physical item identifying information from the smartphone. An example of this is that the user uses the smartphone for performing another payment using Bluetooth® or the like, or simply registers the smartphone with the point of sale via a simple reading by the reading means 312, at the same or a later occasion than the fourth step. Thereby, the smartphone as such is securely connected to the system.

As a result, the smartphone can thereafter be used for performing payments, charging the payment card, without actually using the physical payment card as such. Above, preferred embodiments have been described. However, it is apparent to the skilled person that many modifications can be made to the disclosed embodiments without departing from the basic idea of the invention.

For instance, other types of physical items may be used than the ones 410, 420 described.

The other points of sale 320, 330, apart from 310, may also be equipped with card readers 311.

In general, each registered payment card 500 may be freely used in any connected point of sale 310, 320, 330, or in a predefined or user-specified subset of such points of sale, such as in all restaurants of a particular restaurant chain, and so forth.

The central server 100 may cooperate with several different vendors, or be operated by one single vendor.

It is realized that the registration of the payment card 500 may necessitate the user to enter the conventional PIN code of the payment card into the payment card reader 311 in order to be able to register the payment card 500 with the central server 100.

In general, the above described embodiments and variants are freely combinable, as applicable.

Hence, the invention is not limited to the described embodiments, but can be varied within the scope of the enclosed claims.

What is claimed is:

1. A method for making an electronic payment, the method comprising the following steps, in order:
a) at a first point in time, a central server electronically receiving item identifying information identifying a physical item, the physical item configured to communicate wirelessly, but is not a smartphone;
b) at a second point in time, receiving a physical payment card, the physical payment card is not the physical item, into a physical device of a first point of sale, the device configured to electronically read payment card information from the physical payment card, and the device reading card information which is sufficient to perform the electronic payment;
c) electronically presenting to a first user an option whether to store the payment card information or not, and electronically receiving a response whether to store the payment card information or not;
d) verifying that the response indicates that the payment card information is to be stored;
e) electronically identifying the physical item as the already registered item, and associating, in the central server, the payment card information with the electronically stored item identifying information;
f) at a third, later, point in time, electronically providing, via a local, wireless communication between the physical item and a second point of sale, which wireless communication does not take place over the internet, the electronically stored item identifying information and authenticating a second user by the second point of sale, which authentication is based upon the electronically stored item identifying information;
g) verifying that the authentication in step f) was successful; and
h) performing the electronic payment using the payment card information.

2. The method according to claim 1, wherein, in step f), the electronically stored item identifying information is provided using Bluetooth®, NFC, zigbee or RFID.

3. The method according to claim 1, wherein, in steps f) and h), the physical payment card is used for neither the authentication nor the payment.

4. The method according to claim 1, wherein, in step f), the electronically stored item identifying information is transferred wirelessly from the physical item to the second point of sale.

5. The method according to claim 4, wherein the wireless transfer is performed with the physical item being arranged at the most twenty meters from a corresponding physical wireless receiver of the second point of sale.

6. The method according to claim 1, wherein the first user and the second user is one and the same user.

7. The method according to claim 1, wherein the first point of sale and the second point of sale is one and the same point of sale.

8. The method according to claim 1, wherein the physical device is a physical payment card reader arranged to at least one of read a magnetic stripe, read an electronic circuit of a physical payment card, or read information from a physical payment card via a wireless communication technique.

9. The method according to claim 8, wherein the physical device is caused to be provided with a piece of computer software the execution of which causes the physical device to do at least one of presenting the option to the first user in step c); providing the payment card information to the central server; collecting the electronically stored item identifying information from the first user via an electronic interface; providing the electronically stored item identifying information to the central server; and authenticating the second user at the third point in time.

10. The method according to claim 1, in step c), the user is also presented with at least one additional including one or more of an option as to for what types of purchases the payment card information is to be used, an option of at what points of sale the payment card information is to be used, or an option of a purchase limit to be associated with the payment card information.

11. The method according to claim 1, wherein the electronically stored item identifying information is carried by an electronic transfer device configured to transfer the electronically stored item identifying information to the first point of sale using a wireless communication and the authentication in step f) comprises transferring the electronically stored item identifying information to the second point of sale from the electronic transfer device and verifying the information received.

12. The method according to claim 1, wherein account information, identifying a money account of the first user, is registered in the central server, in that step e) comprises associating the money account to the payment card information in the central server, and wherein the first user is allowed to select a certain threshold value of the money on the money account, and wherein a transfer of funds is arranged to automatically be performed from the physical payment card to the money account when the balance of the money account falls below the threshold.

13. The method according to claim 1, wherein the first user is allowed to register several pieces of electronically stored item identifying information for one and the same physical payment card, wherein different such pieces of electronically stored item identifying information are associated with the same or different users, and wherein such registered pieces of electronically stored item identifying information are associated with one and the same payment card information in the central server upon such registration.
